(19) United States
(12) Patent Application Publication
(10) Pub. No.: US 2004/0098278 A1
(43) Pub. Date: May 20, 2004

(54) Method for returning and reselling merchandise

(75) Inventors: Thomas J. Foth, Trumbull, CT (US); Cornelius S. McNab, New Haven, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/300,090

(22) Filed: Nov. 20, 2002

(51) Int. Cl. G06F 17/60

(52) U.S. Cl. 705/1; 705/26

(57) ABSTRACT

A method is provided for reselling merchandise in which a retail location has in inventory returned merchandise. Information relating to the returned merchandise is communicated from the retailer to a reselling facilitator indicating data relevant to the returned merchandise. The returned merchandise is offered for sale by the reselling facilitator based in part on the data relevant to the returned merchandise. A buyer purchases the returned merchandise from the reselling facilitator whereby the buyer provides at least shipping information indicating where the purchased returned merchandise is to be shipped to. The buyer's shipping information is transmitted from the reselling facilitator to the retailer having the returned merchandise that was purchased by the buyer. The purchased returned merchandise is then shipped from the retailer having it in inventory to the buyer based on the buyers shipping information.

### I. FIELD OF THE INVENTION

This invention relates to a method for returning merchandise from an original buyer to a retailer for resale by a reselling facilitator. More particularly, it relates to a method for reselling returned merchandise, which returned merchandise is shipped directly from the retailer to the new purchaser of the returned merchandise.

### II. BACKGROUND OF THE INVENTION

When an original buyer returns merchandise to a retailer, the original buyer typically must first physically return the merchandise to the retailer, which retailer may or may not directly resell the merchandise. This decision of the retailer to resell the merchandise may be contingent upon the condition of the returned merchandise and whether it was returned in its original packaging and with all of its original enclosure materials. Further contingencies may include whether the returned merchandise is currently being sold by the retailer and/or whether the retailer has ample inventory space for the returned merchandise or whether the retailer has adequate reselling methods to recover the maximum value from returned merchandise. In recent studies by third party logistics providers, approximately 60-80% of all returned merchandise is in condition for resale by the original merchant.

In the event the retailer does not resell the returned merchandise, the retailer typically ships the returned merchandise either back to retailer's warehouse, distributor or to the manufacturer of the returned merchandise. When the returned merchandise is not directly returned to the manufacturer, the retailer's warehouse or distributor then typically ships the returned merchandise to the manufacturer. Once the returned merchandise is shipped to the warehouse or manufacturer, the retailer's warehouse or the manufacturer then typically sorts and ships the returned merchandise to a third party logistics provider. The third party logistics provider then typically inspects and ships saleable returned merchandise either back to the manufacturer, retailer or to a secondary retailer (e.g., auction, outlet store, salvage store).

The above-described process is inefficient as it suffers from several drawbacks. Notably, this process is time consuming as it may involve several shipping routes, with each route necessitating handling and shipping costs. Another notable drawback is the inclusion of a third party logistics provider, which has its own additional cost and delays associated with it.

Thus it is an object of the present invention to provide an improved method for reselling returned merchandise that overcomes the above-noted inefficient drawbacks of the prior art.

### III. SUMMARY OF THE INVENTION

A method is provided for reselling merchandise in which a retail location has in inventory returned merchandise, returned to it by an original buyer. Information relating to the returned merchandise is communicated from the retailer to a reselling facilitator indicating data relevant to the returned merchandise. The reselling facilitator is preferably associated with the retailer and facilitates the sale of merchandise returned to the retailer.

The returned merchandise is offered for sale by the reselling facilitator based in part on the data relevant to the returned merchandise (e.g., description of the merchandise, condition, and it's current location). A buyer purchases the returned merchandise from the reselling facilitator whereby the buyer provides at least shipping information indicating where the purchased returned merchandise is to be shipped to. The buyer's shipping information is transmitted from the reselling facilitator to the retailer having the returned merchandise that was purchased by the buyer. The purchased returned merchandise is then shipped from the retailer having it in inventory to the buyer based on the buyer's shipping information.

### IV. BRIEF DESCRIPTION OF THE DRAWINGS

The above and other objects of the present invention will be apparent upon consideration of the following detailed description, taken in conjunction with the accompanying drawings, in which like reference numerals refer to like parts throughout, and in which:

FIG. 1 is a flowchart depicting the methodology of the present invention;

FIG. 2 is a flow diagram depicting the method of FIG. 1;

FIGS. 3 and 4 are a flow diagram and flowchart depicting an alternative embodiment of the present invention.

### V. DETAILED DESCRIPTION OF THE PREFERRED EMBODIMENT

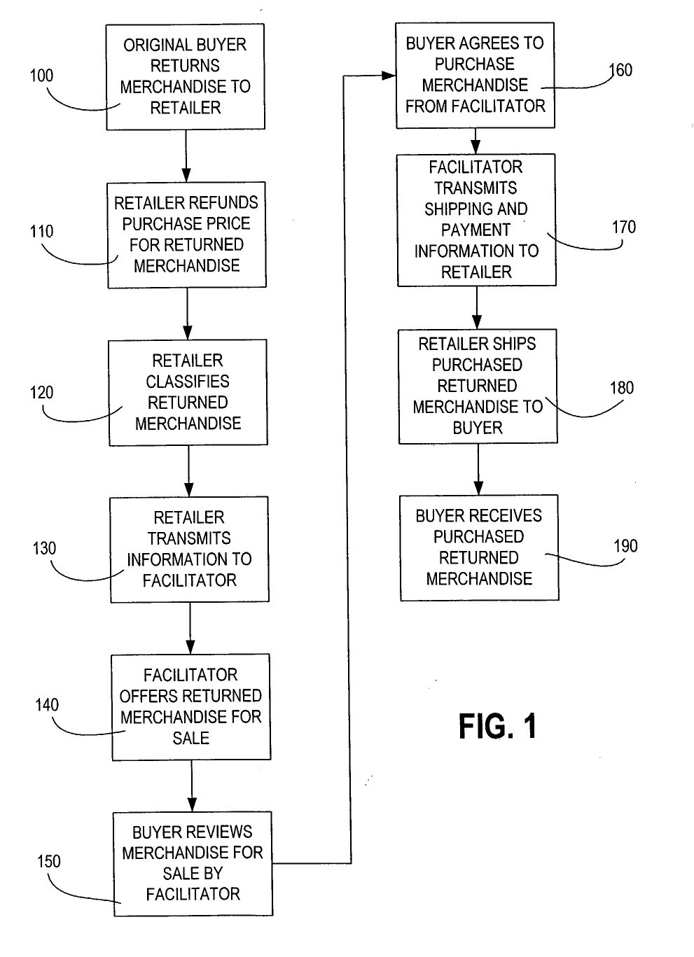

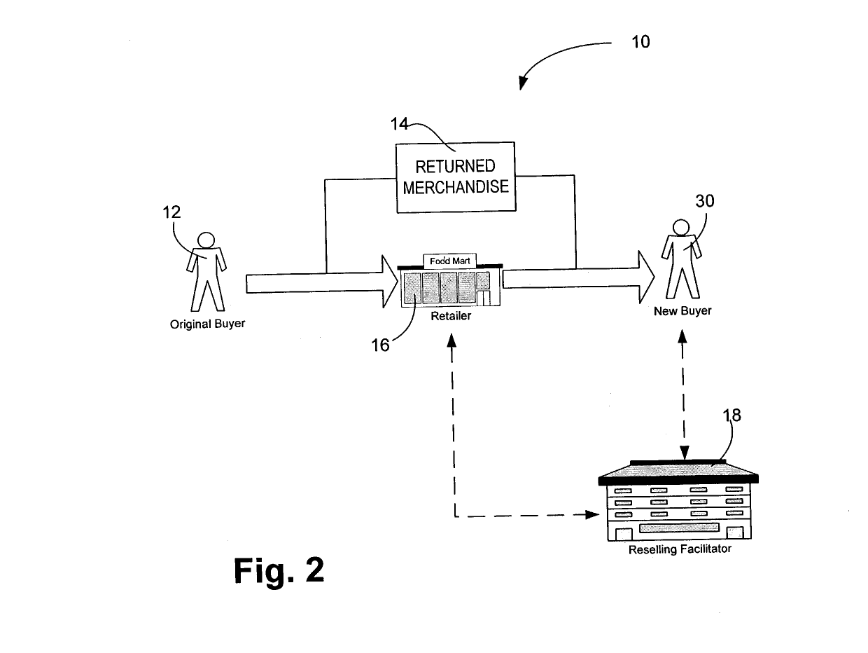

With reference to FIGS. 1 and 2, there is shown a flow chart, illustrated generally by reference numeral 10, depicting the present invention in which an original buyer 12 first returns merchandise 14 to a retailer 16 that preferably originally sold the merchandise to the original buyer 12 (step 100). The retailer 16 then preferably inspects the returned merchandise 14 and either credits or refunds the purchase price paid for the returned merchandise 14 to the original buyer 12 if the merchandise 14 is returned in acceptable condition (step 110). The retailer 16 then classifies the returned merchandise 14 according to prescribed parameters (e.g., condition of the returned merchandise, inclusion of original packaging and enclosure materials, etc.) (step 120).

After classification of the returned merchandise 14, the retailer 16 then enters reselling information regarding the returned merchandise 14 to a reselling facilitator 18 (step 130). It is to be appreciated that the reselling facilitator 18 is preferably a third party that has similar reselling arrangements with numerous other third party retailers and collects a fee for the reselling service it provides. This fee could be paid by the retailer 16, built into the cost of the purchase price of the returned merchandise 14, or paid directly by a buyer 30. Also, the reselling information provided to the facilitator 18 preferably includes a description, quantity, classification and current retail location of the returned merchandise 14. This reselling information can be conveyed from the retailer 16 to the reselling facilitator 18 through any known means of communication including the internet, intranet, telephony (including facsimile), and mail. Afterwards, the reselling facilitator 18 makes available for sale the returned merchandise 14 which can be achieved through any known means of advertising or communication (e.g., email, telemarketing, mail, newspaper or periodical advertisements) (step 140). Preferably, in accordance with the present invention, such sale of the aforesaid returned merchandise 14 is accomplished by the reselling facilitator 18 via a web page(s) on the internet in which the reselling facilitator 18 maintains a web site for listing the sale of the aforesaid returned merchandise 14.

A buyer 30 then is able to view the items for sale by the reselling facilitator 18 (e.g., preferably via the internet) and choose which returned merchandise item to purchase (step 150). It is to be appreciated that in accordance with the present invention a buyer may consist of an individual buyer or a retailer. It is also to be further appreciated that the reselling facilitator 18 is associated with a plurality of buyers 30, preferably via the internet.

Still further, a buyer 30 may be a subscriber to the reselling facilitator 18 whereby the buyer 30 creates a “wish list” of items desired by the buyer 30, which wish list is provided to the reselling facilitator 18 and contains a description of the desired items. The reselling facilitator 18 then queries each wish list to determine if there is a match between the aforesaid items currently offered for sale by the reselling facilitator 18 and the items contained in the wish lists provided to the reselling facilitator 18 by its subscribing buyers 30. If a match is determined, a message is then provided to the buyer 30 indicating such a potential match after which the buyer decides whether or not to purchase the item. For example, a buyer 30 may create a which list consisting of: 1)a laptop computer that is less than 7 lbs. and has between 128-256 MB of RAM available; and 2)a desktop computer that has a processing speed greater than 2 GHz and has at least 512 MB of RAM. After which returned merchandise 14 consisting of a 1)laptop that is 5.2 lbs. with 128 MB of RAM; and 2)a desktop having a processing speed 1.3 GHz with 512 MB of RAM is listed for sale by a retailer 16 with the reselling facilitator 18. Afterwards, the reselling facilitator 18 may determine a match is made between the aforesaid laptops (and not the desktops) and informs the subscribing buyer 30 (preferably via email) of the aforesaid laptop match. The buyer 30 may then further investigate the laptop offered for sale to decide whether or not to purchase the laptop.

In the event a buyer 30 desires to purchase a returned merchandise item from the reselling facilitator 18, the buyer 30 preferably agrees to the terms and conditions for the sale, which is preferably performed via the internet, and provides shipping instructions and payment for the purchased merchandise 14 (step 160). It is to be appreciated that payment can be effected in a number of known methods including check, credit card or third party payment systems, such as Paypal™. Also, shipping cost can be paid by the buyer 30 or retailer 16.

The reselling facilitator 18 then preferably sends a message to the retailer 16 who is in possession of the returned merchandise 14 with payment and instructions indicating where to ship (i.e., the buyer's given address) the returned merchandise 14 (step 170). The retailer 16 then proceeds to ship the purchased returned merchandise 14 to the buyer's given address (step 180), which merchandise 14 is then received by the buyer 30 (step 190).

Thus, the present invention is advantageous in that it 1)eliminates unnecessary shipping of the returned merchandise; 2)enables the returned merchandise to be sold more quickly, reducing loss in value of merchandise over time; and 3)eliminates the need for costly and ineffective third party logistics providers.

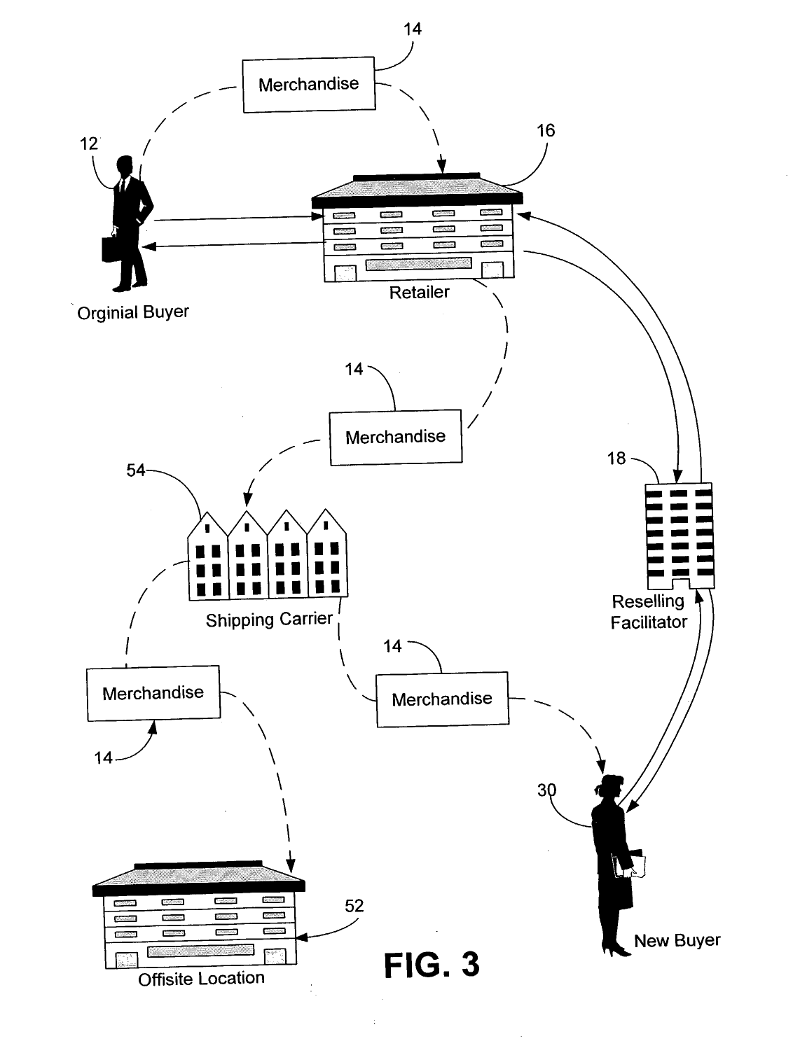

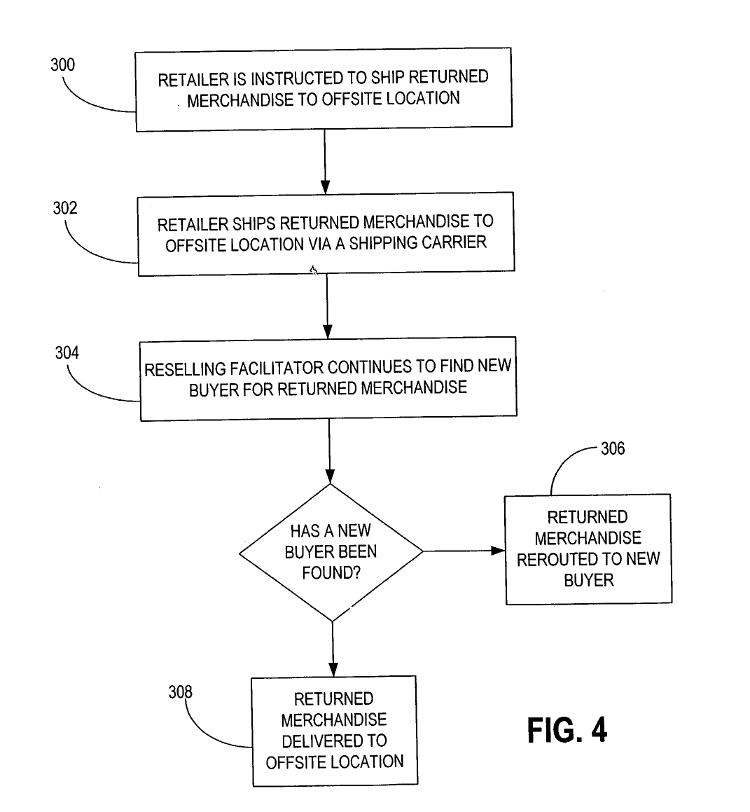

With reference now to FIGS. 3 and 4, it is to be understood that in accordance with another embodiment of the present invention, the returned merchandise 14 may be shipped from a shipping carrier 54 (instead of the retailer 16) to a new buyer 30. In this embodiment, after the original buyer 12 returns the returned merchandise 14 to the retailer 16 (step 100 to step 130, see FIG. 1 and as described above), the reselling facilitator 18 instructs the retailer 16 to preferably ship the returned merchandise 14 to an offsite location 52 (e.g., a restocking warehouse, original manufacturer, etc.) (step 300). It is to be understood that retailer 16 may immediately ship the returned merchandise 14 to the offsite location 52, via a shipping carrier 54, or wait a predetermined time period before shipping the returned merchandise 14 to the offsite location 52 (e.g., while the reselling facilitator 18 attempts to find a new buyer for the returned merchandise 14).

Thus, if a new buyer is not found for the returned merchandise 14 while the returned merchandise 14 is located at the retailer 16 (step 302), the retailer 16 causes the returned merchandise 14 to be shipped to the offsite location 52, via a shipping carrier 54. And while the returned merchandise 14 is in the possession of the shipping carrier 54, the reselling facilitator 18 continues to find a new buyer for the merchandise 14 (step 304). If a new buyer 30 is found (step 306), the shipping carriers 54 routing database is updated with the new buyer's given address so as to facilitate delivery of returned merchandise 14 by the shipping carrier 54 to the new buyer 30. It is noted that this enables the reselling facilitator 18 to use the shipping carrier 54 of the returned merchandise 14 as a virtual short term warehouse, which may be advantageous to the retailer 16 if such a retailer has limited or no storage space for such returned merchandise.

And if the reselling facilitator 18 does not find a new buyer 30 while the returned merchandise is in possession of the shipping carrier 54, the shipping carrier 54 simply proceeds to deliver the merchandise 14 to the address associated with the aforesaid offsite location 52 (step 308). It is further noted that rerouting of the merchandise 14 can occur in at least two points in the shipping carrier's 54 system, namely the point of acceptance for the merchandise 14 or at the destination delivery location of the shipping carrier 54.

Thus, the present invention is advantageous in that it eliminates unnecessary shipping of the returned merchandise and the need for costly and inefficient third party logistics processes.

In summary, a method for reselling returned merchandise has been described. Although the present invention has been described with emphasis on a particular embodiment, it should be understood that many changes and modifications may be made to the invention without departing from the scope and spirit of the invention as disclosed. For example, many modifications and adaptations to the preferred embodiment will be apparent to those skilled in the art. Further, those skilled in the art will appreciate that some aspects of the present invention will be used to advantage without the corresponding use of other aspects.

Accordingly, the foregoing description of the preferred embodiment should be considered as merely illustrative of the present invention and not in limitation thereof.

What is claimed is:

1. A method for reselling merchandise comprising the steps of:
providing a first retail location having returned merchandise;
communicating information from said retail location to a reselling facilitator indicating data relevant to said returned merchandise;
offering for sale said returned merchandise by said reselling facilitator based in part on said data relevant to said returned merchandise;
purchasing said returned merchandise by a buyer from said reselling facilitator wherein said buyer provides at least payment and shipping information indicating where said purchased returned merchandise is to be shipped to;
transmitting said buyer's shipping and payment information from said reselling facilitator to said retailer having said returned merchandise purchased by said buyer;
shipping said purchased returned merchandise from said retail location to said buyer based on said buyers shipping information.

2. A method for reselling merchandise as recited in claim 1 further including the steps of:
creating a list of desired items by said buyer;
providing said list of desired items to said reselling facilitator; and
comparing said list of desired items with returned merchandise to determine if a match exists between said list of desired items and said returned merchandise.

3. A method for reselling merchandise as recited in claim 1 wherein the step of providing a retail location includes the step of an original buyer returning merchandise to the retailer.

4. A method for reselling merchandise as recited in claim 1 wherein the communicating step includes the step using mail to communicate said information from said retail location to said reselling facilitator.

5. A method for reselling merchandise as recited in claim 1 wherein the communicating step includes the step using the internet to communicate said information from said retail location to said reselling facilitator.

6. A method for reselling merchandise as recited in claim 1 wherein the communicating step includes the step using telephony to communicate said information from said retail location to said reselling facilitator.

7. A method for reselling merchandise as recited in claim 1 wherein said data relevant to said returned merchandise includes a description and location of the returned merchandise.

8. A method for reselling merchandise as recited in claim 1 wherein the offering for sale step includes the step of using the internet for offering for sale said returned merchandise.

9. A method for reselling merchandise as recited in claim 1 wherein the offering for sale step includes the step of communicating from the group consisting of: internet, mail and telephony.

10. A method for reselling merchandise as recited in claim 1 wherein the purchasing said returned merchandise step includes the step of the new buyer purchasing the returned merchandise from the group consisting of: internet, telephony and mail.

11. A method for reselling merchandise as recited in claim 1 wherein the transmitting said buyer's information step includes the step of transmitting said buyer's shipping and payment information to the retail location from the group consisting of: internet telephony and mail.

12. A method for reselling merchandise comprising the steps of:
providing a reselling facilitator for reselling returned merchandise;
providing a plurality of retail locations each having at least one piece of returned merchandise and each being associated with said reselling facilitator;
communicating information from at least one said retail location to said reselling facilitator indicating data relevant to said returned merchandise located in at least one said retail location;
offering for sale said returned merchandise by said reselling facilitator based in part on said data relevant to said returned merchandise;
purchasing said returned merchandise by a buyer from said reselling facilitator wherein said buyer provides at least shipping and payment information indicating where said purchased returned merchandise is to be shipped to;
transmitting said buyer's shipping information from said reselling facilitator to a said retailer having said returned merchandise purchased by said buyer;
shipping said purchased returned merchandise from said retail location having said purchased returned merchandise to said buyer based on said buyers shipping information.

13. A method for reselling merchandise as recited in claim 12 further including the steps of:
creating a list of desired items by said buyer;
providing said list of desired items to said reselling facilitator; and
comparing said list of desired items with returned merchandise to determine if a match exists between said list of desired items and said returned merchandise.

14. A method for reselling merchandise as recited in claim 12 wherein the step providing a plurality of retail locations each having at least one piece of returned merchandise includes the step of an original buyer returning merchandise to at least one of the plurality of retail locations.

15. A method for reselling merchandise as recited in claim 12 wherein the communicating step includes the step using mail to communicate said information from at least one of the plurality of retail locations to said reselling facilitator.

16. A method for reselling merchandise as recited in claim 12 wherein the communicating step includes the step using the internet to communicate said information from at least one of the plurality of retail locations to said reselling facilitator.

17. A method for reselling merchandise as recited in claim 12 wherein the communicating step includes the step using telephony to communicate said information from at least one of the plurality of retail locations to said reselling facilitator.

18. A method for reselling merchandise as recited in claim 12 wherein said data relevant to said returned merchandise includes a description and location of the returned merchandise.

19. A method for reselling merchandise as recited in claim 12 wherein the offering for sale step includes the step of for offering for sale said returned merchandise from the group consisting of: internet, telephony and mail.

20. Method for reselling merchandise as recited in claim 12 wherein the purchasing said returned merchandise step includes the step of the buyer purchasing the returned merchandise via the internet.

21. A method fro reselling merchandise as recited in claim 12 wherein the transmitting buyer's information step includes the step of transmitting buyer's shipping and payment information to a retailer location from the group consisting of: internet, telephony and mail.

22. A method for reselling merchandise comprising the steps of:
providing a reselling facilitator for reselling returned merchandise;
providing at least one retail location having at least one piece of returned merchandise and being associated with said reselling facilitator;
communicating information from said at least one retail location to said reselling facilitator indicating data relevant to said returned merchandise located in at least one said retail location;
communicating information from said reselling facilitator to said at least one retail location indicating a predetermined first shipping address;
offering for sale said returned merchandise to a secondary buyer by said reselling facilitator based at least in part on said data relevant to said merchandise to be returned;
purchasing said merchandise to be returned by a said secondary buyer, wherein the secondary buyer provides the returns facilitator with at least a second shipping address.
shipping said merchandise to be returned by said at least one retail location to said first shipping address via a shipping carrier;
communicating information from said reselling facilitator to said shipping carrier indicating said second address;
changing the shipping address of said merchandise to be returned from said first address to said second address while said merchandise to be returned is in possession of said shipping carrier.

23. A method as recited in claim 22 further including the step of shipping said merchandise to be returned to said first shipping address in the event a said secondary buyer is not found for said merchandise to be returned.

24. A method for reselling merchandise as recited in claim 22 further including the steps of:
creating a list of desired items by said buyer;
providing said list of desired items to said reselling facilitator; and
comparing said list of desired items with returned merchandise to determine if a match exists between said list of desired items and said returned merchandise.
